(19) United States
(12) Patent Application Publication
(10) Pub. No.: US 2002/0107709 A1
(43) Pub. Date: Aug. 8, 2002

(54) Method and apparatus for collecting and communicating information related to validity of a patent over a global information network

(75) Inventors: Thomas J. Colson, Clarence, NY (US); Samuel C. Baxter, Fairport, NY (US)

Correspondence Address: SIMPSON & SIMPSON, PLLC, 5555 MAIN STREET, WILLIAMSVILLE, NY, 14221-5406, US

(73) Assignee: IP.Com, Inc., West Henrietta, NY (US)

(21) Appl. No.: 09/778,635

(22) Filed: Feb. 7, 2001

(51) Int. Cl. G06F 17/60

(52) U.S. Cl. 705/7

(57) ABSTRACT

A method and apparatus for collecting and communicating information related to validity of a patent over a global information network, including the steps of soliciting bounty hunters via a global information network for prior art related to validity of the patent, receiving substantive information related to the validity of the patent from at least one of the bounty hunters in response to the solicitation, sanitizing the substantive information to remove indicia of source, and, submitting sanitized substantive information to a bounty offeror.

### FIELD OF THE INVENTION

This invention relates generally to a method and apparatus for collecting and communicating information related to validity of a patent over a global information network.

### BACKGROUND OF THE INVENTION

National and global markets, industry, medicine, science, communication, education, governments, the law, routines that guide our daily lives, and even our future prosperity all depend on a smooth exchange of information. The ongoing exponential growth of information and information sources is creating problems in locating information that meets our specific needs. The glut of information is, however, only one obstruction. Another is that the information we need is sometimes difficult to locate because of geographical and language constraints. The information being sought could be found in Russian literature, Japanese patents, Chinese textbooks, or German university theses, for example. Sources such as these, although public, are often not easily accessible to most information searchers.

The field of intellectual property provides an excellent example of the need to access such difficult to access information. Traditionally, the number of patent applications filed each year with the Patent and Trademark Office increases. Patent Examiners review each new application for patentability. To receive patent protection, an invention must be new, useful, and have been nonobvious to a person having ordinary skill in the art at the time the invention was made. Novelty and nonobviousness are determined by analyzing the claimed invention in view of the prior art. Prior art is often found in issued patents, in pending applications that have been published, journal articles, professional meeting abstracts, books, and various other sources that include such diverse material as university theses and advertising literature. It is simply not possible for patent Applicants and Examiners to review all of the possibly relevant published literature.

Information relevant to the validity of an issued patent is also sometimes difficult to find. In patent infringement litigation, it is not uncommon for defendants to search the “ends of the earth” for pertinent prior art. But, again, language barriers and the like often prevent a comprehensive search.

Because of all of the problems associated with finding relevant prior art, an increasing number of overly broad patents are allowed each year. An overly broad patent often serves as the basis for a patent infringement action. An alleged infringer, of course, seeks to show that the patent at issue is invalid. An issued patent can be invalidated by evidence showing that the invention was not novel or that the invention was obvious to a person having ordinary skill in the art at the time the invention was made. This is often accomplished by finding evidence that the invention was in use, on sale, or published or patented sometime before the application date of the patent. This hard-to-find information is valuable for several other reasons.

Before investing in a start-up company having a patent as an asset, venture capitalists need assurance that the patent can withstand court scrutiny. New market-place entrants, or competitors who would like to advance in a given market, need to find applicable prior art to avoid the possibility of their product being accused of infringing. Companies who provide patent insurance would surely want to be knowledgeable about the strength of the patent to be insured.

To find relevant references, companies and individuals often hire a search firm to do their searching. The cost for a search ranges from a few hundred to a few hundred thousand dollars with no guarantee as to the outcome. What was needed was a way to find prior art without risking considerable sums of money. In other words, the goal is to pay only for successful search results. What was also needed was a way to provide incentives to a large indefinite number of potential searchers to search for, locate, and/or communicate pertinent information of which they are aware.

By analogy, this is a problem faced by law enforcement personnel every day. Rewards have been posted and offered for information about criminals since the days of the Wild West. These types of rewards have often been referred to as bounties, and bounty hunters survive today as the best evidence that the system's incentives are successful.

One attempt to address this problem is found on the World Wide Web Bounty Quest site at www.bountyquest.com. Bounty Quest has established a website to post information about patents and to solicit third parties (bounty hunters) to submit information related to the validity of the posted patent. As the name suggests, Bounty Quest enables customers to place a bounty on a specific patent, seeking invalidating references from anyone in the world. Searchers are encouraged by the bounty. Arguably, the bigger the bounty the more enthusiastic the searchers will be. Those placing bounties will not have to pay (other than a one time $2500 fee for placing the bounty on Bounty Quest's web site) unless their needs are met. The requirements for payment of the bounty are determined solely by the offeror of the bounty.

The specific process is set forth on the Bounty Quest web site, but, in summary, the process works as follows. A bounty, of a minimum of ten thousand dollars, and the specific requirements that must be met (usually the reference will have to qualify as an anticipatory reference) to earn the bounty are posted on the Bounty Quest website. Bounty hunters are advised, via the web site, as to the date the bounty offer will close (generally three months). During that time, bounty hunters may submit prior art references to Bounty Quest. On the day that the bounty offer closes, Bounty Quest packages the submitted references and sends them to the bounty offeror. The bounty offeror then has a designated period of time to review and rank the references according to their relevance to the posted requirements. The bounty offeror then announces which bounty hunter, if any, is the winner of the bounty.

In the case of multiple submissions from bounty hunters, the first to submit a reference that meets the requirements wins the bounty. The Bounty Quest system permits a bounty hunter to send an email notification to Bounty Quest to advise that he has a pertinent reference. This email message is time-stamped as to date of transmission. In the case of multiple submissions, this time-stamp is used to determine whose submission was first in time. The bounty hunter then has one week to submit the actual reference.

This method, however, suffers from several disadvantages. Determination of whether a prior art reference is a legitimate anticipatory reference is not an easy task, and probably requires analysis by legal counsel. Obviously, the final determination can only be made by the Patent Office or a court of competent jurisdiction. Therefore, the bounty offeror has great discretion in determining which reference merit payment of a bounty. Theoretically, the bounty offeror could reject the submitted references as non-anticipatory, avoid payment of the bounty, and then use the references in an obviousness-type attack on the validity of the subject patent. Or, the bounty offeror could reject the references, avoid paying the bounty, and then use them to attack the validity of the patent. Such misappropriation would be very difficult for Bounty Quest (or anyone else) to police or to prove. Misappropriation might occur even more often in situations where the reference is sought for reasons other than patent invalidation, such as by a venture capitalist where the objective is simply to know if good references are in the public domain. It is obvious then, that while a bounty type system offers incentives for searchers, the Bounty Quest system provides no assurances or guarantees of payment to the bounty hunter.

Although it is clear that there is a need for a more efficient and effective way to solicit, collect and communicate information relative to validity of a patent, there is also a need to protect the bounty hunters who participate in such a system.

### SUMMARY OF THE INVENTION

The present invention generally comprises a method and apparatus for collecting and communicating information related to validity of a patent over a global information network, including the steps of soliciting bounty hunters via a global information network for prior art related to validity of the patent, receiving substantive information related to the validity of the patent from at least one of the bounty hunters in response to the solicitation, sanitizing the substantive information to remove indicia of source, and, submitting sanitized substantive information to an information purchaser.

A general object of the present invention to provide an efficient, effective, and economical method for finding difficult to find information.

Another object of this invention to provide a method of ensuring that the qualified information finder is compensated.

These and other objects, features and advantages of the present invention will become apparent to those having ordinary skill in the art upon a review of the following detailed description in view of the appended claims.

### BRIEF DESCRIPTION OF THE DRAWINGS

FIG. 1 is a representative flow diagram of a prior art system for collecting and communicating information related to validity of a patent over a global information network, offered commercially at www.bountyquest.com;

FIG. 2 is a representative flow diagram of the present invention illustrating the improved sanitization process of the invention; and,

FIG. 3 is a representative flow diagram illustrating the sanitization process in more detail.

### DETAILED DESCRIPTION OF THE PREFERRED EMBDODIMENT

The present invention is an improvement over the commercially available method of doing business offered by Bounty Quest via its web site www.bountyquest.com. As described above, Bounty Quest, through its web site, offers an opportunity for bounty offerors to post information relative to a patent on its site, and to solicit bounty hunters for information relative to the validity of the posted patent. At present, it appears that only information relative to validity relative to novelty qualifies for payment of a bounty. Moreover, bounty hunters who submit prior art references to Bounty Quest are, at present, unprotected in that Bounty Quest apparently communicates the reference as well as all details related to its publication (place, date, etc.) to the bounty offeror for determination by the bounty offeror as to whether the reference meets its requirements for payment of a bounty. Under this system, the bounty offeror obtains the most valuable information the bounty hunter has to offer — bibliographic information related to the reference, without making a commitment to the bounty hunter to pay the bounty.

The present invention is a simple improvement over this business model. The present invention as claimed provides a mechanism for the web site host to sanitize the information submitted by the bounty hunter prior to communication to the bounty offeror. By “sanitize” it is meant that all bibliographic information related to the submitted information (prior art reference) is excised prior to submission to the bounty offereor. The theory underlying the present invention is that the bounty offeror does not need to have the bibliographic information in order to make a determination as to whether the reference meets the requirements for payment of the bounty. “Sanitize” also may optionally include removal of the identity of the bounty hunter, since, in some instances, it may be preferable to conceal the identity of the bounty hunter from the bounty offeror.

In the business model now offered by Bounty Quest and engendered by the present invention, the bounty offeror determines the criteria for which a bounty is paid. Usually, although not necessarily, the reference submitted by the bounty hunter must be capable of invalidating a patent for lack of novelty. In other words, the reference must comprise an anticipatory prior art reference. (Under U.S. law, the requirement of novelty is specified in 35 U.S.C. §102, although it is envisioned that the present invention will be useful in invalidating domestic and foreign patents, and has applications outside of patent invalidity.) The present invention also engenders the solicitation of non-anticipatory references as well. For example, obviousness-type prior art references may be solicited (in the United States, the requirement of non-obviousness is specified in 35 U.S.C. §103, although it is envisioned that the present invention will be useful in invalidating foreign patents in accordance with the specific laws of foreign countries), or general information sought by venture capitalists or other investors may be sought. Finally, it should be appreciated that the present invention as claimed is not limited to patents of any one country. It is appreciated that patent laws vary from country to country, and that the criteria for invalidating patents also varies from country to country. Since the criteria for the solicited information is determined by the bounty offeror, the system is not country specific or limited.

In the detailed description of the invention which follows, the following definitions apply:

Web site: A server computer system located on a global computer network (the Internet), which is identified by a unique identification system known as a Uniform Resource Locator (“URL”) where a remote client computer system specifies the URL for that web site in a request (e.g., a HyperText Transfer Protocol (“HTTP”) request). The web site utilizes Hyper-Text Markup Language (“HTML”) which provides a standard set of tags that defme how a web page (a web site may comprise one or more web pages) is to be displayed. The client computer system accesses web sites through the use of a browser. A browser (such as Netscape Navigator or Microsoft Internet Explorer) is a special-purpose application program that accesses web pages and the displaying of web pages.

Reference: A publication, book, article, diagram, text, illustration, photograph or other printed material.

Anticipatory reference: A reference which anticipates the invention or elements of the invention and which has an effective date prior to the time the invention in question was made. An “anticipatory reference” in the United States is a reference that would be arguably material to patentability of an invention pursuant to 35 U.S.C. §102. An anticipatory reference, generally, is a reference that would tend to show that a particular invention as claimed is not novel.

Bounty offeror: A party who solicits information relative to a patent and establishes certain criteria regarding information about the patent and offers a reward for obtaining that information. In another embodiment, the bounty offeror may offer a reward for other information, not necessarily related to a patent.

Bounty hunter: A party who communicates information in response to the posting of a bounty by a bounty offeror. The expectation of the bounty hunter is to locate specific information meeting certain criteria set by the bounty offeror in exchange for a reward.

Prior art: Prior art comprises all information known, described, disclosed, discovered, published, sold or used having an effective date prior to the time the invention in question was made, or the subject patent application was filed. Under U.S. law, prior art is typically that published information useful in attacking the validity of a patent under 35 U.S.C. §§102, 103.

Global information network: A vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system.

Substantive information: A portion of text, illustrations, diagrams, photographs or content of a prior art reference.

Substantive information related to validity of a patent: A portion of text, illustrations, drawings, diagrams, photographs or content of a prior art reference material to patentability of a patented invention, or validity of an issued patent.

Sanitize: The method of omitting bibliographic information from references found by a bounty hunter prior to disclosing that information to the bounty offeror. “Sanitize” may also mean the act of removing the identity of the bounty hunter from a submission prior to transmission of the reference to the bounty offeror.

Bibliographic information: The description, identification and source of the editions, dates of issue, authorship, and typography of books, articles, or other written material.

Escrow agent: In the present invention, a host operates as a confidential depository of information and an impartial liaison between the bounty offeror and the bounty hunter. The information provided by the bounty hunter is submitted to the host in confidence. The host “sanitizes” the information to remove bibliographic and/or identity of bounty hunter information. The remaining “substantive information” is then forwarded by the host to the bounty offereor for review. The sanitized information is “held in escrow” by the host until the bounty offeror advises the host that a bounty (reward) will be paid for the information. The host will then coordinate the transfer of the reward from offeror to hunter and the release of the bibliographic information to the offeror. Thus, in this scenario, the host acts as an escrow agent.

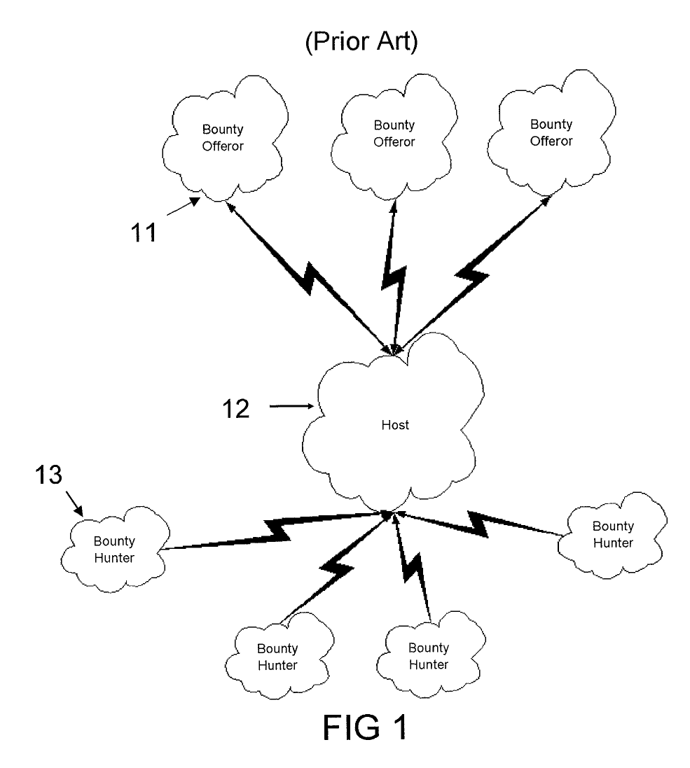

FIG. 1 illustrates a flow diagram of a prior art invention, the www.bountyquest com system. In this system, a host web site 12 acts as a liason between one or more bounty offerors 11 and one or more bounty hunters 13. The essence of the BountyQuest system is described on its website as follows:

“What is BountyQuest?

BountyQuest is the Internet destination where companies post large cash rewards for vital information.

Finally, individuals around the globe can be rewarded for what they know.

The rapidly growing, high-stakes patent world is the source of BountyQuest's first rewards, where access to fugitive information helps resolve today's raging patent controversies.

First time users click here!

Urgent: Knowledge Wanted!

A lot of companies today are being sued for patent infringement. They are forced to spend large amounts of money, time, and effort to research the patent in question. What they need is the ability to simply pay for the information showing that the patent in question is invalid. If the patent is valid, they need to know that too. It saves them money, time, and in some cases, it can even save their businesses.

High-Stakes Knowledge Marketplace

You won't find $5 or $10 questions at BountyQuest. We are here to surface the market for the $10,000-$1,000,000 questions. Companies already spend that kind of money trying to find information but they can't get results as quickly and cost-effectively as they can with BountyQuest.

Broadcast Reward System™

BountyQuest believes that some kinds of information can be found by a Bounty-Based system more effectively than any other. Rewards for information is a simple and time honored principle, in the old west: “Wanted, Dead or Alive,” and on your comer light post: “Lost dog reward”. Bounties work best for information that already exists, and can be found only by the right person. All that needs to be done is to get the message out to the right people and provide an incentive large enough to make it worth their while. That's why we call our method the “Broadcast Reward System”: we broadcast the rewards to the world. However, we also “Narrow-Cast” by letting experts sign up to be notified whenever a topic in their area of interest comes up.

Human Search Engines

The Internet may be huge, but most of the information that exists can not be found by searching it. Consider the following: libraries and bookstores around the world hold millions of books in hundreds of languages that are not online or centrally cataloged in any way. The Internet itself is in hundreds of languages, and no one person is fluent in all of them. A lot of information is not recorded anywhere. Can you find out who was your Second Grade teacher by using a search engine? What we really need is a way to search people's brains, and we're a long way from having that technology! However that's just what BountyQuest provides: the ability to tap into the knowledge of experts.

Patent Reform Tool

Patent officials do the best they can to search for “Prior Art,” or proof that an invention being patented is not new. However, they can't search all of the world's libraries and brains any more than you can. BountyQuest offers a new tool for ensuring the validity of patents. Whenever a patent is in question, a reward for Prior Art can be posted on BountyQuest. If the patent is not really new, BountyQuest can turn up the proof, and eliminate the invalid patent. If the patent is really new, a search on BountyQuest that comes up empty will help to demonstrate that as well. The end result will be a patent system with fewer invalid patents, and more public confidence in the quality of the remaining patents.

Prior Art Search Database

One day, all the world's literature, from all history, in every language may be in a central database that can be searched with simple English queries like “Has a method for exercising cats using a laser pointer been described?” Or maybe not. Until then, BountyQuest's Broadcast Reward System™ is closest thing.

Old techniques for finding prior art have included hand searching at the U.S. Patent and Trademark Office and other foreign patent offices, keyword searching through on-line databases, and traditional library researching. Although these techniques can work well, they are time consuming and incomplete. We at BountyQuest believe that the fundamental flaw with these existing techniques is that they require a small team of researchers, typically junior attorneys, to become experts on an entire field of research, for all its history; a daunting if not impossible task.

BountyQuest offers a new way to find prior art. Rather than ask a few novices to learn everything that has ever happened in a field, we ask all the experts in the field if they know of a reference that is relevant. Thus, we distribute the search over thousands of researchers who are already familiar with the jargon, the people, and the history of the field.

BountyQuest recognizes a fundamental truth: you can't substitute clever keyword searches for a lifetime of learning. We can get better results faster, because all we do is ask people to tell us what they already know. The collective minds of tens of thousands of researchers can yield more useful information in one day, than hand searching at the USPTO can deliver in a month. Also, our researchers can tell us where to look for the art, not just whether they have any art.”

Quoted from BountyQuest website at www.bountyquest.com, Feb. 5, 2001.

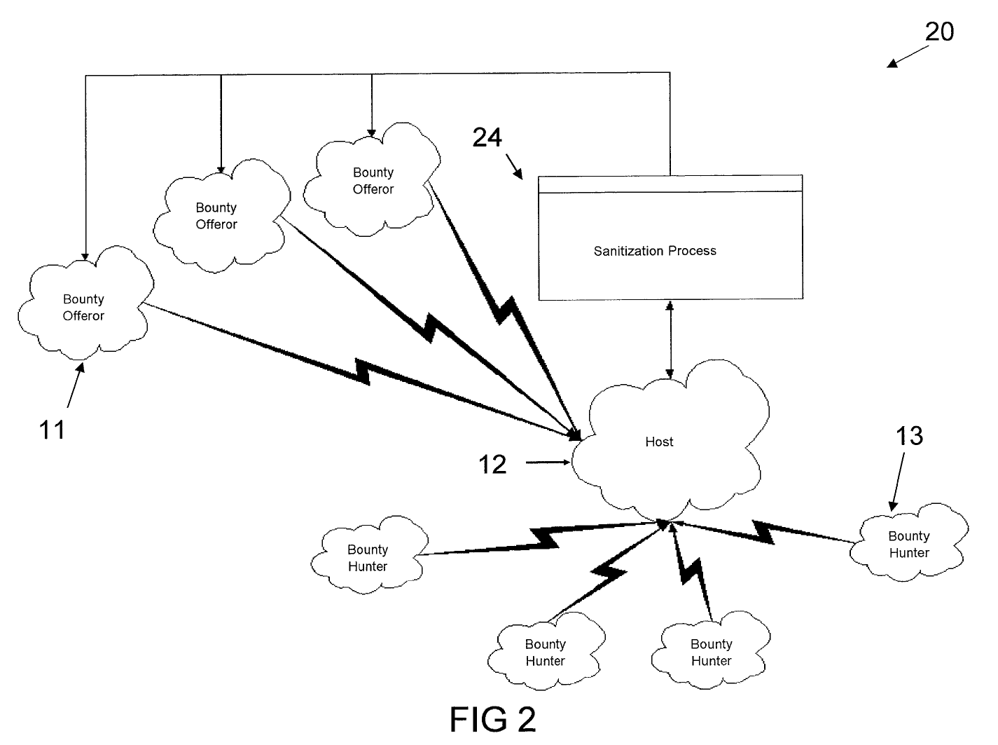

Although the BountyQuest website provides a useful service, the present inventors believe the system can be improved by offering better protection to the bounty hunters (the searchers). An improved system 20 is illustrated in FIG. 2. In the system illustrated in FIG. 2, information provided to the host by bounty hunters 13 is sanitized to remove bibliographic information relative to the submission, or to remove the identity of the bounty hunter. In a preferred embodiment illustrated in FIG. 2, the sanitization process 24 is done under the control of host 12. The sanitization can be accomplished in a number of ways, and can be done either at the server (host) or client (bounty hunter) location. In a preferred embodiment, all bibliographic information is transmitted from the bounty hunter to the host, but the bibliographic information is held in escrow by the host pending determination by the bounty offeror as to whether payment of the bounty reward should be made. Only after the bounty offeror advises that a reward is merited will the host release the bibliographic information to the offeror. The host may even withhold the bibliographic information until it receives the reward from the offeror, holding both the reward and bibliographic information in escrow.

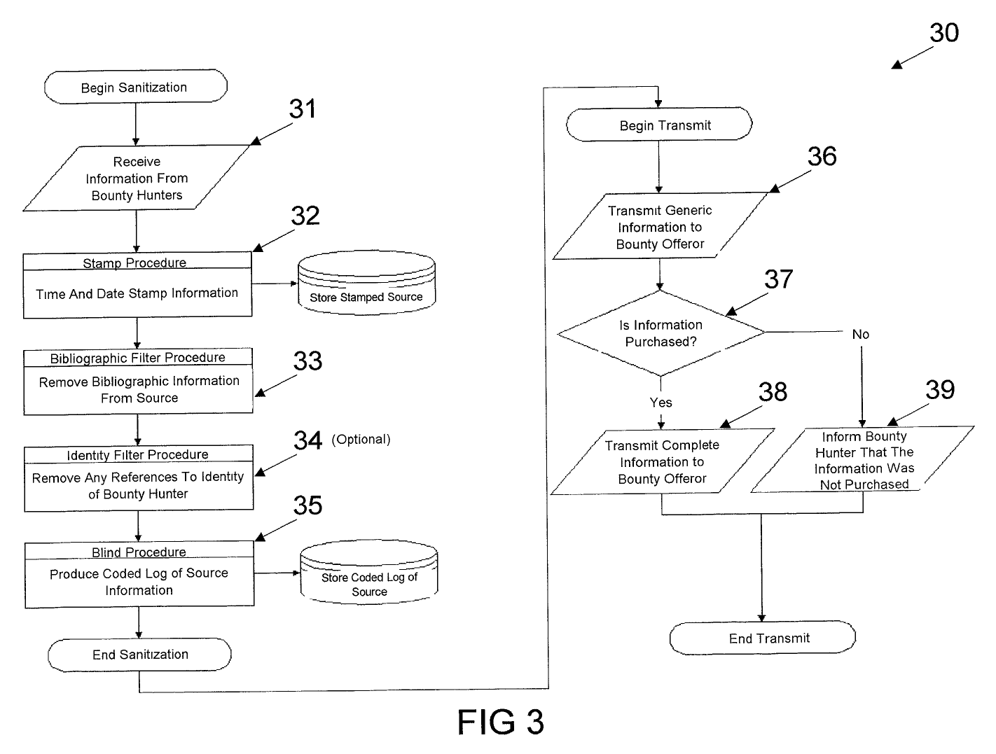

Although there are many different ways in which the submitted information can be sanitized, one method is disclosed and illustrated in FIG. 3. In this embodiment, information is received from a bounty hunter at 31 by the host, and then date and time stamped at 32. The date and time stamp indicate the time and date of receipt of the information from the bounty hunter. Since most rewards are made on a “first come — first served” basis, the time and date of submission is important. After time and date stamping, a bibliographic filter 33 is applied to remove certain information related to publication of the information (name of publisher, place and date of publication, author, etc.) Optionally, the identity of the bounty hunter may be removed by filter 34. Of course, once the bibliographic filter has been applied, it is necessary to create a coded log to correlate the filtered source information with the substantive information submitted to the bounty offeror. This is done by log generator 35. The generic substantive information is then communicated to the bounty offeror at 36. The bounty offeror then makes a determination 37 as to whether the substantive information received meets certain predefined requirements for payment of a bounty. In a preferred embodiment, the requirements are determined by the bounty offeror, although it is suggested that the requirements could be objectively predetermined, or determined by a party other than the bounty offeror (such as the host, for example). In the embodiment shown in FIG. 3, if the bounty offeror determines that the information does not meet the requirement, she informs the host (or the bounty hunter) at 39 of this decision. If the bounty offeror decides that the information meets the requirements, then the host transmits the complete bibliographic information to the bounty offeror at 38. It is contemplated that the host may act as an escrow agent even for the bounty reward itself In other words, the host may receive the bounty reward from the offeror prior to sending the bibliographic information.

The invention will now be described by the following non-limiting examples.

### EXAMPLE 1

For example, if company ABC is sued for infringement of a United States patent, it could place a bounty offer of $100,000 on a host website. Searchers (bounty hunters) who find references submit them to the host company, XYZ he Bounty business). XYZ, Inc. then strips the reference documents of all identifying information and provides them to company ABC (the bounty offeror) for review. ABC determines that one reference document is suitable as an anticipatory reference (regardless of what a court or the Patent Office says downstream) and provides payment to the bounty hunter, through XYZ company. XYZ company then provides the actual reference document (with bibliographic information) to company ABC.

### EXAMPLE 2

In the same scenario described in Example 1, after reviewing the stripped reference documents, Company ABC determines that none of the documents are suitable anticipatory references, but believes that two references combined would support a strong obviousness-type argument for invalidity. Company ABC can then place an offer to the searchers in an amount less than the bounty amount. Each of the searchers (bounty hunters) then can make their own decision as to the value of their reference document.

### EXAMPLE 3

Another example is a venture capitalist, VC, that is considering an investment in Moneyplease, Inc. Moneyplease is a small company with very few barriers to entry other than a very strong patent. Without the patent, Moneyplease's market position is not strong. VC does not want to invest unless it is certain that the patent can withstand scrutiny. VC posts the patent on Company XYZ website (the host) with a bounty in the amount of $50,000. Bounty hunters from all over the world uncover 15 references. The same process occurs as in the first example, and upon reviewing the stripped reference documents, VC is satisfied that none of the references are strong anticipatory or obviousness-type references and can confidently do the deal with no need to buy any references.

### EXAMPLE 4

In another embodiment, the bounty offeror can simply post a patent for search and not specify any bounty. Instead, the offeror could solicit references and the bounty hunters can independently negotiate the fee for the reference after providing the offeror with the text of the reference document in generic format.

### EXAMPLE 5

The site can be used for the difficult task of product clearance. Essentially, before building or launching a new product, companies often hire search firms to search for patents that might be infringed by the new product. As described above, a bounty can be offered for a product description. The customer can anonymously place a list of product features up for bounty. Results could be provided in the form of a bullet list of claim limitations (with brief arguments as to why infringed if desired), and the customer placing the bounty can evaluate the results in the same manner. As in the “second example” above, this would be attractive to insurance companies providing patent insurance to new product launches.

What is claimed is:

1. A method for collecting and communicating information related to validity of a patent over a global information network, comprising:
a) soliciting bounty hunters via a global information network for prior art related to validity of said patent;
b) receiving substantive information related to said validity of said patent from at least one of said bounty hunters in response to said solicitation; and,
c) sanitizing said substantive information.

2. The method of claim 1 further comprising the step of submitting said sanitized substantive information to a bounty offeror.

3. The method of claim 2 further comprising the step of paying a bounty to one of said bounty hunters a bounty when said received substantive information meets specific requirements.

4. The method of claim 2 wherein said specific requirements are specified by said bounty offeror.

5. The method of claim 1 wherein said sanitizing comprises removal of information related to publication of said substantive information.

6. The method of claim 1 wherein said sanitizing comprises removal of information related to identity of the third party who submitted said substantive information.

7. The method of claim 1 further comprising the step of time-stamping submissions of bounty hunters in response to said solicitation to determine chronological order of receipt.

8. The method of claim 1 further comprising the step of comparing at least two submissions of substantive information received in response to said solicitation to determine if substantive information received from one of said bounty hunters differs from substantive information received from another of said bounty hunters.

9. The method of claim 8 further comprising the step of submitting a plurality of sanitized substantive information disclosures to a bounty offeror when said comparison indicates that different substantive information has been received from at least two of said bounty hunters.

10. The method of claim 9 further comprising the step of paying a bounty to at least one of said bounty hunters when certain requirements are met.

11. A method for brokering information between at least two parties over a global information network, comprising:
a) soliciting bounty hunters via a global information network for published information;
b) receiving said published information from at least one of said bounty hunters in response to said solicitation; and,
c) sanitizing said published information.

12. The method of claim 11 further comprising the step of submitting said sanitized published information to a bounty offeror.

13. The method of claim 12 further comprising the step of paying one of said bounty hunters a bounty when said received substantive information meets specific requirements.

14. The method of claim 12 wherein said specific requirements are specified by said bounty offeror.

15. The method of claim 11 wherein said sanitizing comprises removal of information related to publication of said substantive information.

16. The method of claim 12 wherein said sanitizing comprises removal of information related to identity of the third party who submitted said substantive information.

17. The method of claim 11 further comprising the step of time-stamping submissions of bounty hunters in response to said solicitation to determine chronological order of receipt.

18. The method of claim 11 further comprising the step of comparing at least two submissions of substantive information received in response to said solicitation to determine if substantive information received from one of said bounty hunters differs from substantive information received from another of said bounty hunters.

19. The method of claim 18 further comprising the step of submitting a plurality of sanitized substantive information disclosures to a bounty offeror when said comparison indicates that different substantive information has been received from at least two of said bounty hunters.

20. The method of claim 19 further comprising the step of paying a bounty to at least one of said bounty hunters when certain requirements are met.

21. An apparatus for collecting and communicating information related to validity of a patent over a global information network, comprising:
a) means for soliciting bounty hunters via a global information network for prior art related to validity of said patent;
b) means for receiving substantive information related to said validity of said patent from at least one of said bounty hunters in response to said solicitation; and,
c) means for sanitizing said substantive information.

22. The apparatus recited in claim 21 wherein said means for soliciting comprises a page on a web site.

23. The apparatus recited in claim 21 wherein said means for receiving substantive information comprises e-mail.

24. The apparatus recited in claim 21 wherein said means for sanitizing comprises a computer programmed to extract information related to publication of said substantive information.

25. The apparatus recited in claim 21 wherein said means for sanitizing comprises a computer programmed to extract information related to source of said substantive information.

26. An apparatus for brokering information between at least two parties over a global information network, comprising:
a) means for soliciting bounty hunters via a global information network for published information;
b) means for receiving said published information from at least one of said bounty hunters in response to said solicitation; and,
c) means for sanitizing said published information.

27. The apparatus recited in claim 26 wherein said means for soliciting comprises a page on a web site.

28. The apparatus recited in claim 26 wherein said means for receiving substantive information comprises e-mail.

29. The apparatus recited in claim 26 wherein said means for sanitizing comprises a computer programmed to extract information related to publication of said substantive information.

30. The apparatus recited in claim 26 wherein said means for sanitizing comprises a computer programmed to extract information related to source of said substantive information.
